(19) United States
(12) Patent Application Publication
(10) Pub. No.: US 2006/0175246 A1
(43) Pub. Date: Aug. 10, 2006

(54) Filter apparatus

(75) Inventor: Akiyoshi Komine, Yokohama (JP)

Correspondence Address: BRINKS HOFER GILSON & LIONE, P.O. BOX 10395, CHICAGO, IL, 60610, US

(73) Assignee: YAMASHIN-FILTER CORP.

(21) Appl. No.: 11/347,488

(22) Filed: Feb. 3, 2006

Related U.S. Application Data
(60) Provisional application No. 60/650,222, filed on Feb. 4, 2005.

(51) Int. Cl. B01D 35/28

(52) U.S. Cl. 210/444; 210/443; 210/445; 210/455

(57) ABSTRACT

The invention provides a filter apparatus wherein the filter element alone is replaceable and thus the case of the filter cartridge can be reused as is and not discarded. In a filter apparatus where fluid that flows in from an inlet in a head, passes through a filter element and flows out from an outlet in the head, the filter cartridge which is removably attached to the head comprises a case with a threaded ring on its outside peripheral surface that encloses a filter element and a retaining ring that retains it, and by using the threaded ring to removably fasten the retaining ring to the case, the filter element is fixed in position within the case, but by loosening the threaded ring from the retaining ring, the filter element can be removed from within the case and discarded.

This application claims priority to provisional application No. 60/650,222 filed Feb. 4, 2005, the entire content of which is incorporated herein by reference.

### BACKGROUND OF THE INVENTION

1. Field of the Invention

The present invention relates to a filter apparatus used, for example, in the fluid recirculation system of a hydraulic circuit or the like, in order to catch foreign matter, contaminants, pollutants and the like in the fluid.

2. Description of the Related Art

This type of filter apparatus is provided with a head having an inlet and an outlet, and a filter cartridge constituting a filter element enclosed within a case, and the filter cartridge is removably attached to the head. Thus, fluid flowing through the fluid recirculation system flows in from the inlet of the head and flows into the filter cartridge, and then passes through the filer element and flows out from the outlet of the head, so that the foreign material and the like within the fluid is caught and removed by the filter element as the fluid passes through the filter element.

Conventionally, the filter element had been firmly fixed within the case by means of crimping or other fixing means. With use, the filter element undergoes gradual degradation of its performance due to clogging and the like, and thus must be periodically replaced.

Conventionally, the filter element constitutes a filter cartridge that is firmly incorporated into and formed as a unit with the case, and for this reason, when the time to replace the filter element comes, the entire filter cartridge is removed from the head and discarded, and then a new filter cartridge is installed in the head. To wit, the filter element is discarded together with the case and a new filter cartridge is installed in the head each time the filter element is replaced.

There are thus problems in that this increases the amount of waste generated, is not environmentally responsible and is wasteful from the standpoint of conservation of resources, and there is an additional problem in that replacement costs are increased because an entire new filter cartridge is required each time the filter element is replaced.

### BRIEF SUMMARY OF THE INVENTION

The present invention came about in light of such problems, and has as its object to provide a filter apparatus whereby, at the time of replacement of the filter element, it is possible to replace only the filter element as the main component, the case can be reused as is and not discarded, and is thus advantageous from a standpoint of environmental responsibility and resource conservation also the cost at the time of filter element replacement can be reduced.

An aspect of the present invention is to provide a filter apparatus comprising a head having an inlet and an outlet, and a filter cartridge constituting a filter element enclosed within a case, where the filter cartridge is removably attached to the head, and where fluid that flows in from the inlet of the head into the interior of the filter cartridge passes through the filter element and flows out from the outlet of the head, wherein: the filter cartridge comprises a case with a threaded ring on its outside peripheral surface that encloses a filter element, and a retaining ring that retains this filter element, and by using the threaded ring to removably fasten the retaining ring to the case, the filter element is fixed in position within the case, but by loosening the threaded ring from the retaining ring, the filter element can be removed from within the case.

Another aspect of the present invention is to provide a filter apparatus comprising a head having an inlet and an outlet, and a filter cartridge constituting a filter element enclosed within a case, where the filter cartridge is removably attached to the head, and where fluid that flows in from the inlet of the head into the interior of the filter cartridge passes through the filter element and flows out from the outlet of the head, wherein: the filter cartridge comprises a filter element provided with a retaining ring enclosed within a case with a threaded ring on its outside peripheral surface, and by using the threaded ring to removably fasten the retaining ring to the case, the filter element is fixed in position within the case, but by loosening the threaded ring from the retaining ring, the filter element can be removed from within the case.

Another aspect of the present invention is to provide a filter apparatus wherein the filter cartridge is removably attached to the head via the threaded ring.

Another aspect of the present invention is to provide a filter apparatus wherein end plates are attached to either end of a filter medium formed in the shape of a cylinder and also a tube is provided on the inside surface or outside surface of the filter medium or on both surfaces, and the end plates and tubes are removably attached to the filter medium.

### BRIEF DESCRIPTION OF SEVERAL VIEWS OF THE DRAWINGS

FIG. 1 is a cross section of a filter apparatus according to a first embodiment of the invention, shown in the assembled state.

FIG. 2 is a cross section of a filter apparatus according to a first embodiment of the invention, shown in the disassembled state.

FIG. 3 is a cross section of a filter apparatus according to a second embodiment of the invention, shown in the assembled state.

FIG. 4 is a cross section of a filter apparatus according to a second embodiment of the invention, shown in the disassembled state.

### DETAILED DESCRIPTION OF THE INVENTION

Here follows a detailed description of embodiments of the present invention made with reference to the drawings.

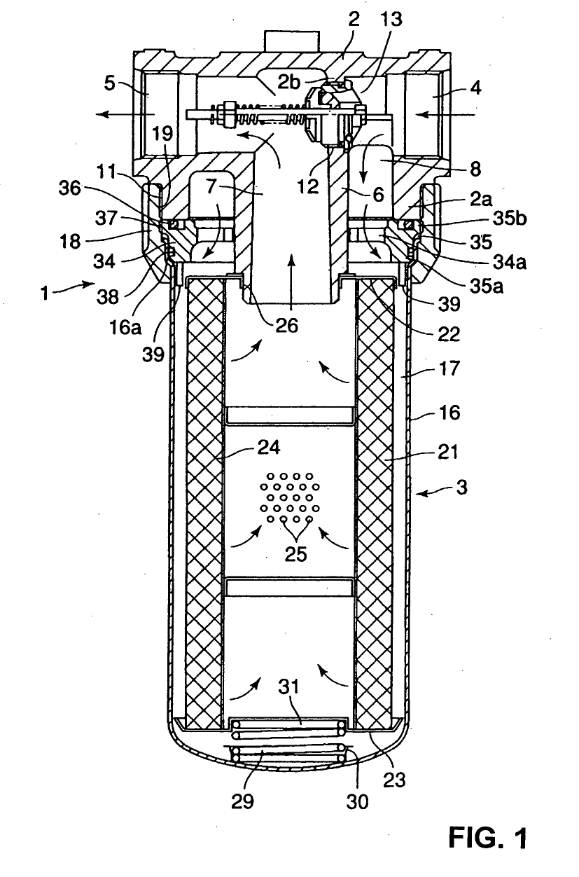

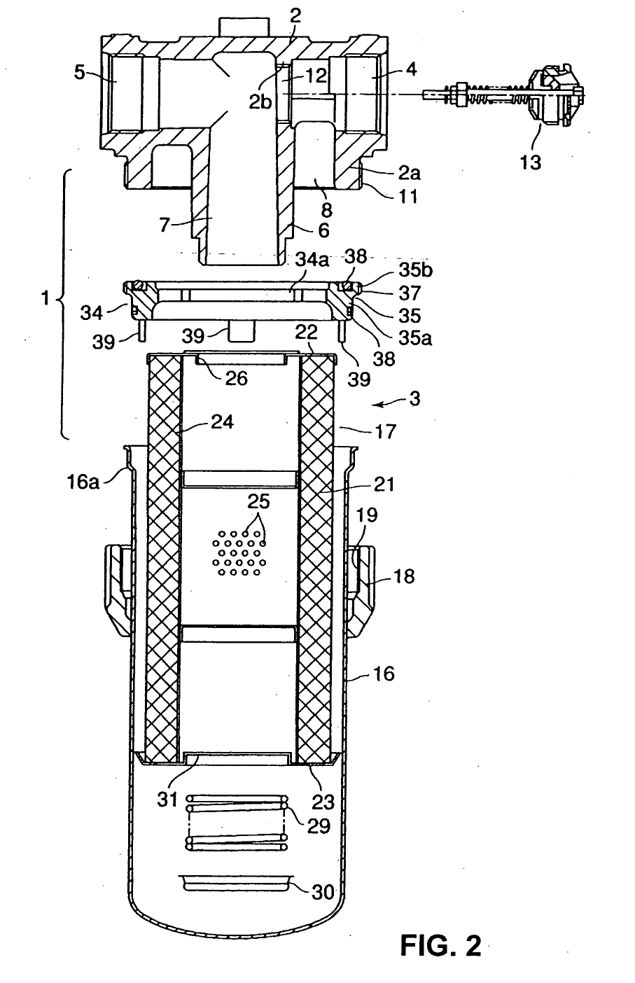

FIG. 1 is a cross section of a filter apparatus according to a first embodiment of the invention, shown in the assembled state, while FIG. 2 shows the filter apparatus, in the disassembled state.

This filter apparatus 1 comprises a head 2 and a filter cartridge 3 removably attached to this head 2. Upon the head 2 are formed an inlet 4 at one end and an outlet 5 at the other end, and also a downward-protruding connecting tube 6 is formed in the middle; the interior of this connecting tube 6 becomes an outflow channel 7 leading to the outlet 5, while the annular space between the outside surface of the connecting tube 6 and the bottom peripheral wall 2a of the head 2 becomes an inflow channel 8 leading to the inlet 4.

A thread 11 is formed on the outside peripheral surface of the bottom peripheral wall 2a of the head 2, and a pass-through hole 12 that directly connects the inlet 4 to the outlet 5 is formed in a wall area 2b between the inlet 4 and outlet 5, while a relief valve 13 which serves as a safety valve that is actuated in case of abnormally high pressures is installed within this pass-through hole 12.

The filter cartridge 3 comprises a case 16 in the shape of a cylinder that is closed at one end and a filter element 17 enclosed within this case 16, while a threaded ring 18 is rotatably attached to the outside peripheral surface of this case 16 such that it can freely move in the axial direction. A thread 19 is formed on the inside surface of this threaded ring 18.

A step 16a that extends outwards is formed in the upper part of the outside peripheral surface of the case 16, and the lower part of the threaded ring 18 engages this step 16a so as to prevent the threaded ring from coming off.

The filter element 17 may comprise, for example: a filter medium 21 made of corrugated filter paper, nonwoven cloth or the like formed into a cylinder; first and second end plates 22 and 23 attached to either end of this filter medium 21; and a cylindrical tube 24 mounted between the end plates 22 and 23 so as to be in contact with the inside surface of the filter medium 21. Many fine pores 25 are formed at equal intervals over the entire peripheral surface of the tube 24, and a mating hole 26 that communicates with the interior of the filter medium 21 is formed in the center of the first end plate 22.

The head 2 and the case 16 and threaded ring 18 of the filter cartridge 3 are each made of metal, and the end plates 22 and 23 and tube 24 of the filter element 17 are each made of metal or a synthetic polymer.

A spring 29 and a spring mount 30 that accepts the bottom end of this spring 29 are provided inside the base of the case 16, and an indentation 31 that accepts the top end of the spring 29 is formed in the center of the second end plate 23.

A metal retaining ring 34 separate from the filter element 17 is provided between the case 16 and head 2. This retaining ring 34 has the shape of a ring having an inside hole 34a, and a step 35 is formed on its outside peripheral surface, so this step 35 makes the lower part of the retaining ring 34 a smaller-diameter part 35a and the upper part a larger-diameter part 35b.

Thus, the smaller-diameter part 35a can fit inside the inside surface of the case 16 at its upper edge, while the larger-diameter part 35b protrudes from the upper edge side of the case 16. An O-ring or other seal 36 is provided on the outside peripheral surface of the smaller-diameter part 35a, and a thread 37 that can engage the thread 19 of the threaded ring 18 is formed on the outside peripheral surface of the larger-diameter part 35b.

An O-ring or other seal 38 is provided on the upper surface of the retaining ring 34, positioned toward the periphery, and a plurality of tongue-shaped holding pieces 39 are formed at equal intervals so as to protrude from the lower surface of the retaining ring 34 toward the outside edge.

Here follows a description of the procedure for assembling this filter apparatus 1.

As shown in FIG. 2, first insert the filter element 17 into the case 16. Next, pull the threaded ring 18 upward and fit the retaining ring 34 within this threaded ring 18, and rotate the threaded ring 18 or retaining ring 34 relative to the other, and tighten with the threads 19 and 37 screwed into each other. This causes the smaller-diameter part 35a of the retaining ring 34 to fit securely into the inside surface of the upper end of the case 16, thereby assembling a filter cartridge 3 with a unitary structure.

When the retaining ring 34 is fit onto the upper end of the case 16, the retaining ring 34 pushes the filter element 17 within the case 16 against the elastic force of the spring 29, thus compressing the spring 29 so that its elastic force causes the top end surface of the filter element 17 to come into elastic contact with the bottom surface of the retaining ring 34, and thus the filter element 17 is stably secured at the stipulated position within the case 16.

In addition, the plurality of holding pieces 39 that protrude from the bottom surface of the retaining ring 34 are disposed around the periphery of the upper end of the filter element 17 and support its upper end, so any movement of the filter element 17 is prevented and thus the filter element 17 is stably secured within the case 16.

When a filter cartridge 3 thus assembled is to be installed in the head 2, the threaded ring 18 is fitted to the outside peripheral surface of the bottom peripheral wall 2a of the head 2 and also the threaded ring 18 is rotated as a unit with the case 16 and other components so that the thread 19 of the threaded ring 18 engages the thread 11 of the head 2 and is thus tightened. Thereby, the top surface of the retaining ring 34 is sealed tightly to the bottom surface of the bottom peripheral wall 2a by means of the intervening seal 38, thus installing the filter cartridge 3 in the head 2.

At this time, the tip of the connecting tube 6 of the head 2 passes through the inside hole 34a of the retaining ring 34, thus entering and fitting within the mating hole 26 in the filter element 17, so that the outflow channel 7 within the connecting tube 6 communicates with the interior of the filter medium 21. In addition, the bottom surface of the bottom peripheral wall 2a of the head 2 is tightly sealed to the top surface of the retaining ring 34, so that the inflow channel 8 within the bottom peripheral wall 2a communicates with the space between the outside surface of the filter medium 21 and the inside surface of the case 16 through the inside hole 34a of the retaining ring 34.

Assembly of the filter apparatus 1 is thus completed by installing the filter cartridge 3 in the head 2 in this manner. In this assembled state, fluid enters from the inlet 4, passes through the inflow channel 8 and sequentially flows in toward the outside of the filter medium 21. This fluid then passes through the filter medium 21 and the fine pores 25 in the tube 24 and flows into the inside of the filter medium 21. When the fluid passes through the filter medium 21, foreign matter and the like within the fluid is caught by the filter medium 21 and thus removed. The fluid that flows into the inside of the filter medium 21 then sequentially flows out from the outlet 5 through the outflow channel 7 of the head 2.

On the other hand, when the performance of the filter element 17 has degraded and it is thus its time for replacement, first loosen the threaded ring 18 and remove the threaded ring 18 from the bottom peripheral wall 2a of the head 2, and then take the filter cartridge 3 out of the head 2.

Next, rotate the retaining ring 34, or threaded ring 18 of the filter cartridge 3 to unscrew the threaded ring 18 from the retaining ring 34 and remove the retaining ring 34 from the case 16.

Once the opening at the top end of the case 16 is opened by removing the retaining ring 34, remove the filter element 17 from the case 16 through the opening at the top end.

The filter element 17 thus removed should be disposed of by the proper disposal route. The case 16, threaded ring 18 and retaining ring 34 can then be reused and not discarded.

To wit, clean the disassembled case 16, threaded ring 18 and retaining ring 34, install a new filter element 17 within the case 16 and use the threaded ring 18 and retaining ring 34 to assemble the filter cartridge 3 by the same procedure as described previously, and then install this filter cartridge 3 in the head 2 and thus reuse the case 16, threaded ring 18 and retaining ring 34.

We shall now present an example of an efficient mode of management in the case in which the filter element 17 is discarded and the case 16, threaded ring 18 and retaining ring 34 are reused. First, when it is time to replace the filter element 17, the user removes the filter cartridge 3 from the head 2. This filter cartridge 3 is collected by the company that manufactures the cartridges or their agent or the like.

The company that manufactures the cartridges or their agent or the like then disassembles the filter cartridge 3, disposes of the filter element 17 via the proper disposal route, cleans the case 16, threaded ring 18 and retaining ring 34, inserts a new filter element 17 into the case 16, and uses the threaded ring 18 and retaining ring 34 to assemble a new filter cartridge 3, which is then provided to the user.

In this manner, when the time comes to replace the filter element 17, only that filter element 17 is discarded and replaced with only a new filter element 17, and so the case 16, threaded ring 18 and retaining ring 34 can be reused as is and not discarded.

Thus, the present invention can contribute to reducing the amount of waste generated, improving environmental responsibility and conservation of resources, and the case 16, threaded ring 18 and retaining ring 34 of the filter cartridge 3 can be reused as is, so the costs at the time of replacing the filter element 17 can be reduced.

The threaded ring 18 in the filter cartridge 3 functions as a member that locates the filter element 17 contained within the case 16 via the retaining ring 34 at a stipulated location within the case 16, and moreover, this threaded ring 18 functions as a removable securing member that removably secures the filter cartridge 3 to the head 2.

To wit, it is possible to use a single threaded ring 18 to securely locate the filter element 17 within the case 16 and also removably secure the filter cartridge 3 to the head 2, and thus the structure is simplified and the number of parts is reduced, so the cost of manufacturing the filter apparatus 1 can be reduced.

Note that the end plates 22 and 23 and tube 24 of the filter element 17 can be formed from combustible synthetic polymer, and in this case, the filter element 17 removed from the case 16 can be disposed of as is by incineration.

In addition, a constitution wherein the end plates 22 and 23 and tube 24 of the filter element 17 are provided such that they are removably secured to the filter medium 21 is also possible, and in this case, the filter element 17 removed from the case 16 can be disassembled such that the filter medium 21 is separated from the end plates 22 and 23 and the tube 24, so the filter medium 21 can be disposed of as is by incineration.

With the filter element according to the aforementioned embodiment, a tube is provided on the inside surface of the filter medium, but for the purpose of strengthening the filter medium, the tube may be provided on the outside surface of the filter medium, or tubes may be provided on both the inside and outside surfaces. Moreover, the end plates at either end of the filter medium may be removably secured to the filter medium, and in this case also, the filter element removed from the case can be disassembled such that the filter medium is separated from the end plates and the tube, so the filter medium can be disposed of as is by incineration.

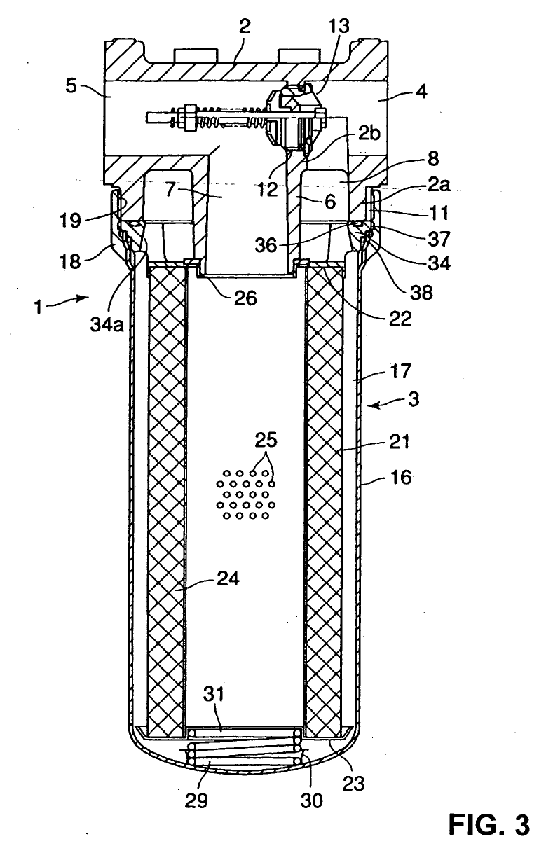

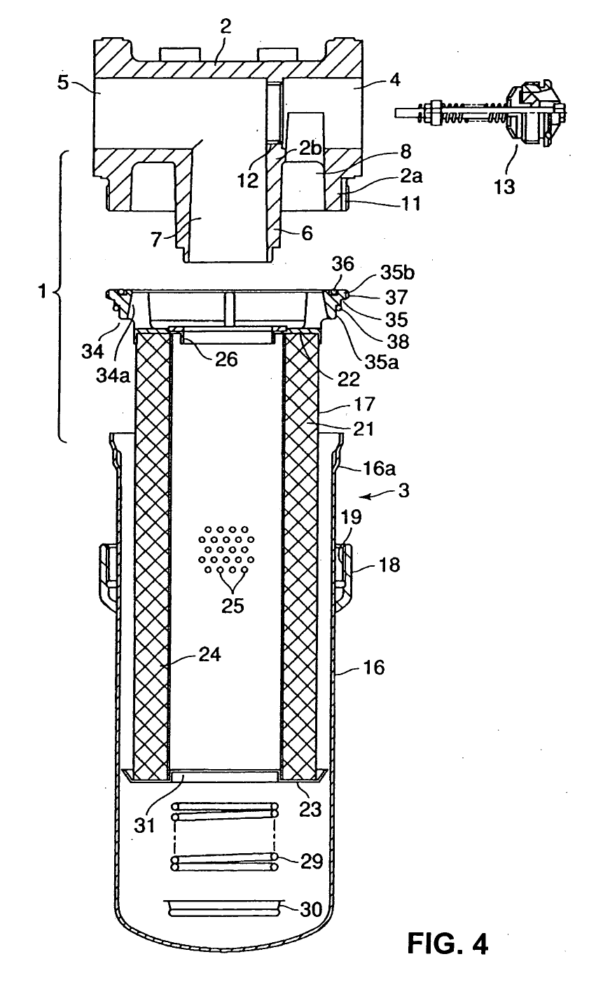

FIGS. 3 and 4 illustrate a second embodiment of the invention, and in this embodiment, the retaining ring 34 is attached to the top end of the filter element 17 in a fixed manner, so that the filter element 17 and retaining ring 34 are formed as a unit.

In the case of this second embodiment, when assembling the filter cartridge 3, insert the filter element 17 into the case, pull the threaded ring 18 upward, fit the retaining ring 34 within this threaded ring 18, rotate the threaded ring 18 or retaining ring 34 relative to the other, and tighten with the threads 19 and 37 screwed into each other. This causes the smaller-diameter part 35a of the retaining ring 34 to fit securely into the inside surface of the upper end of the case 16, thereby assembling a filter cartridge 3 with a unitary structure.

When the retaining ring 34 is fit onto the upper end of the case 16, the retaining ring 34 pushes the filter element 17 within the case 16 against the elastic force of the spring 29, thus compressing the spring 29 so that its elastic force supports the bottom end of the filter element 17. The filter element 17 is fixed to the retaining ring 34 as a unit, so the filter element 17 is stably secured at the stipulated position within the case 16.

When a filter cartridge 3 is to be installed in the head 2, the threaded ring 18 is fitted to the outside peripheral surface of the bottom peripheral wall 2a of the head 2 and also the threaded ring 18 is rotated as a unit with the case 16 and other components so that the thread 19 of the threaded ring 18 engages the thread 11 of the head 2 and is thus tightened. Thereby, the top surface of the retaining ring 34 is sealed tightly to the bottom surface of the bottom peripheral wall 2a by means of the intervening seal 38, thus installing the filter cartridge 3 in the head 2.

At this time, the tip of the connecting tube 6 of the head 2 passes through the inside hole 34a of the retaining ring 34, thus entering and fitting within the mating hole 26 in the filter element 17, so that the outflow channel 7 within the connecting tube 6 communicates with the interior of the filter medium 21. In addition, the bottom surface of the bottom peripheral wall 2a of the head 2 is tightly sealed to the top surface of the retaining ring 34, so that the inflow channel 8 within the bottom peripheral wall 2a communicates with the space between the outside surface of the filter medium 21 and the inside surface of the case 16 through the inside hole 34a of the retaining ring 34.

Assembly of the filter apparatus 1 is thus completed by installing the filter cartridge 3 in the head 2 in this manner. In this assembled state, fluid enters from the inlet 4, passes through the inflow channel 8 and sequentially flows in toward the outside of the filter medium 21. This fluid then passes through the filter medium 21 and the fine pores 25 in the tube 24 and flows into the inside of the filter medium 21. When the fluid passes through the filter medium 21, foreign matter and the like within the fluid is caught by the filter medium 21 and thus removed. The fluid that flows into the inside of the filter medium 21 then sequentially flows out from the outlet 5 through the outflow channel 7 of the head 2.

On the other hand, when the performance of the filter element 17 has degraded and it is thus its time for replacement, first loosen the threaded ring 18 and remove the threaded ring 18 from the bottom peripheral wall 2a of the head 2, and then take the filter cartridge 3 out of the head 2.

Next, rotate the retaining ring 34 or threaded ring 18 of the filter cartridge 3 to unscrew the threaded ring 18 from the retaining ring 34 and remove the filter element 17 from the case 16 together with the retaining ring 34.

The retaining ring 34 and filter element 17 thus removed should be disposed of by the proper disposal route and the case 16 and threaded ring 18 can then be cleaned and reused and not discarded.

In this manner, when the time comes to replace the filter element 17, only the filter element 17 provided with a retaining ring 34 is discarded and replaced, so the case 16 and threaded ring 18 can be reused as is and not discarded.

Thus, the present invention can contribute to reducing the amount of waste generated, improving environmental responsibility and conservation of resources, and the case 16 and threaded ring 18 of the filter cartridge 3 can be reused as is, so the costs at the time of replacing the filter element 17 can be reduced.

Note that in either of the embodiments described above, the threaded ring 18 is rotatably attached to the outside peripheral surface of this case 16 such that it can freely move in the axial direction, but the threaded ring 18 may also be fixed to the top edge of the case 16 and provided as a unit therewith.

With an aspect of the present invention, at the time of replacement of the filter element, it is possible to replace only the filter element, so the case, threaded ring and retaining ring of the filter cartridge can be reused as is and not discarded, and this is thus advantageous from a standpoint of environmental responsibility and resource conservation also the cost at the time of filter element replacement can be reduced.

With another aspect of the present invention, at the time of replacement of the filter-element, it is possible to replace only the filter element provided with a retaining ring, so the case and threaded ring of the filter cartridge can be reused as is and not discarded, and this is thus advantageous from a standpoint of environmental responsibility and resource conservation also the cost at the time of filter element replacement can be reduced.

With another aspect of the invention, it is possible to use the threaded ring that securely locates the filter element within the case also to removably secure the filter cartridge to the head, and thus the structure is simplified and the number of parts is reduced, so the cost of manufacturing the filter apparatus can be reduced.

With another aspect of the invention, it is possible to disassemble the filter element removed from the case in order to discard only the filter medium.

1. A filter apparatus comprising:
a head having an inlet and an outlet;
a filter cartridge comprising an open end and a closed end;
a attaching mechanism configured to removably attach the head to the open end of the filter cartridge;
a filter element enclosed in the filter cartridge, wherein fluid that flows in from the inlet of the head into an interior of the filter cartridge passes through the filter element and flows out from the outlet of the head; and
a retaining member adapted to retain the filter element inside the filter cartridge, wherein the retaining member is secured to the filter cartridge to retain the filter element inside the filter when the head is attached to the filter cartridge, whereas the retaining member becomes separable from the filter cartridge, whereby the filter element becomes removable from the filter cartridge for replacement, when the head is detached from the filter cartridge.

2. A filter apparatus according to claim 1, wherein the retaining member holds the filter element in place.

3. A filter apparatus according to claim 1, wherein the attached mechanism comprises a thread formed on the head and a threaded ring provided on the filter cartridge, wherein the threaded ring engages the thread to fix the head to the filter cartridge.

4. A filter apparatus according to claim 3, wherein the threaded ring slidably provided around an outside periphery of the filter cartridge, and the filter cartridge has a stopper at the open end thereof to stop the threaded ring at the open end.

5. A filter apparatus according to claim 1, wherein the head comprises an exit passage communicating with the outlet, wherein the exit passage becomes in communication with an interior of the filter element when the head is attached to the filter cartridge.

6. A filter apparatus according to claim 1, wherein the head comprises an entry passage communicating with the inlet, wherein the entry passage becomes in communication with a space created between the interior of the filter cartridge and an exterior of the filter element.

7. A filter apparatus according to claim 1, wherein the head comprises a third passage communicating with both the inlet and outlet and closed with a relief valve.

8. A filter apparatus according to claim 1, further comprising a spring configured to urge the filter element out from the open end of the filter cartridge.

9. A filter apparatus according to claim 1, wherein the filter element has one end which is open and another end which is closed.

10. A filter apparatus according to claim 1, wherein the filter element comprises a filter medium and end plates removably attached to both ends of the filter medium.

11. A filter apparatus according to claim 1, wherein the filter apparatus is used in a fluid recirculation system of a hydraulic circuit.
